(19) United States
(12) Patent Application Publication
(10) Pub. No.: US 2026/0149837 A1
(43) Pub. Date: May 28, 2026

(54) IMPLICIT NEURAL REPRESENTATION TREE

(71) Applicant: Nokia Technologies Oy, Espoo (FI)

(72) Inventor: Hamed REZAZADEGAN TAVAKOLI, Espoo (FI)

(21) Appl. No.: 19/177,912

(22) Filed: Apr. 14, 2025

Related U.S. Application Data
(60) Provisional application No. 63/634,651, filed on Apr. 16, 2024.

(51) Int. Cl. H04N 19/96; H04N 19/119; H04N 19/129; H04N 19/169

(52) U.S. Cl. CPC H04N 19/96; H04N 19/119; H04N 19/129; H04N 19/188

(57) ABSTRACT

An apparatus includes circuitry configured to: analyze content of a plurality of regions of data, wherein the data comprises at least one or more of: an image or video; split the data into a plurality of partitions corresponding to the plurality of regions of the data; determine sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; store information corresponding to the partition corresponding to the region of data with a neural network parameter tree; and encode the data split into the plurality of partitions.

### RELATED APPLICATION

This application claims priority to U.S. Provisional Application No. 63/634,651, filed Apr. 16, 2024, which is herein incorporated by reference in its entirety.

### TECHNICAL FIELD

The examples and non-limiting embodiments relate generally to multimedia transport and, more particularly, to an implicit neural representation tree.

### BACKGROUND

It is known to perform data compression and data decompression in a multimedia system.

### SUMMARY

In accordance with an aspect, an apparatus includes at least one processor; and at least one memory storing instructions that, when executed by the at least one processor, cause the apparatus at least to: analyze content of a plurality of regions of data, wherein the data comprises at least one or more of: an image or video; split the data into a plurality of partitions corresponding to the plurality of regions of the data; determine sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; store information corresponding to the partition corresponding to the region of data with a neural network parameter tree; and encode the data split into the plurality of partitions into or along a bitstream.

In accordance with an aspect, an apparatus includes at least one processor; and at least one memory storing instructions that, when executed by the at least one processor, cause the apparatus at least to: decode, from or along a bitstream, data split into a plurality of partitions corresponding to a plurality of regions of the data, wherein the data comprises at least one or more of: an image or video; wherein sizes of the partitions are based on an analysis of content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; decode information corresponding to the partition corresponding to the region of data from a neural network parameter tree; and reconstruct the image or video from the plurality of partitions corresponding to the plurality of regions of the data.

In accordance with an aspect, an apparatus includes at least one processor; and at least one memory storing instructions that, when executed by the at least one processor, cause the apparatus at least to: produce content of a region of data using a neural network, wherein the data comprises at least one or more of: an image or video; store information about the neural network using a neural network parameter tree; encode the information about the neural network into or along a bitstream; and encode the neural network parameter tree into or along the bitstream.

In accordance with an aspect, an apparatus includes at least one processor; and at least one memory storing instructions that, when executed by the at least one processor, cause the apparatus at least to: decode, from or along a bitstream, information about a neural network; and decode, from or along the bitstream, information from a neural network parameter tree used to store information about the neural network; wherein content of a region of data is produced using the neural network, wherein the data comprises at least one or more of: an image or video.

### BRIEF DESCRIPTION OF THE DRAWINGS

The foregoing embodiments and other features are explained in the following description, taken in connection with the accompanying drawings, wherein:

FIG. 1 shows an example of partitioning of an input frame.

FIG. 2 shows an example of uneven partition.

FIG. 3 shows schematically a user equipment suitable for employing embodiments of the examples described herein.

FIG. 4 is a block diagram illustrating a system in accordance with an example.

FIG. 5 is an example apparatus configured to implement the examples described herein.

FIG. 6 shows a representation of an example of non-volatile memory media used to store instructions that implement the examples described herein.

FIG. 7 shows an encoder according to an embodiment.

FIG. 8 shows a decoder according to an embodiment.

FIG. 9 is an example method, based on the examples described herein.

FIG. 10 is an example method, based on the examples described herein.

FIG. 11 is an example method, based on the examples described herein.

FIG. 12 is an example method, based on the examples described herein.

FIG. 13 shows an example INR tree.

FIG. 14 shows an example neural network tree.

### DETAILED DESCRIPTION OF EXAMPLE EMBODIMENTS

Described herein is a tree structure of processing of multimedia using implicit neural representations. The herein described approach defines a scene or alternatively multimedia content in terms of regions represented by a tree. Each tree node contains the information with respect to a neural network that regenerates the scene. The neural network receives information about the grid, e.g., for videos the spatial location on the grid and time-index and for 3D content the positional information and temporal information of the scene and produces the content of that location.

Described herein is the encode and decode process and the tree node required data structure required for the proper encode and decode of the multimedia content.

Also described herein is an efficient method for retrieving the relevant neural networks for each node of the content tree during compression and their transfer for the purpose of multimedia content representation.

Implicit neural visual representations for 2D content relates to approaches for representing a video in terms of a neural network. For some neural representations for videos, it is possible to represent a complete video frame as a neural network. That is given a time index, the neural network generates a complete video frame corresponding to this time index. The technique may be advanced by combining the concept of neural representations for videos with a neural video codec. It results in a small content adaptive neural network representation that is adapted to the frames and overfitted to the video frames. In one approach a time index is used, however the frame is split into patches in terms of a grid, and the location of the patch in the grid is provided as well as the time index, i.e., (x, y, t) where x, y encodes positional location of the patches and t represents time.

Using a tree structure for implicit neural compression is an approach that determines a tree-structure, more precisely, an octree is used for neural network parameter sharing. It encodes the medial images, which comprise a 3D volume. This architecture takes as input the output of parent node in the octree. In other words, the tree in this structure is used for partitioning and sharing hidden parameters of neural networks with respect to the local regions. In contrast, the tree structure as described herein does not take the parent node output as input, but rather receives the partition information corresponding to the content and patch related information. The examples described herein also involve 2D content as input rather than 3D volume and tackle the aspects relevant to time dimension.

Compression of a multimedia time-varying signal, e.g., video; by representing it as a neural network is not as competitive as conventional video coding tools. It, however, has some advantages, e.g., a functional representation of a discrete signal that makes it appealing for avoiding discretization deficiencies. It allows implementing digital services and enhancements seamlessly over the neural representation.

Proper neural architectures and systems for improving the compression performance of implicit neural representations is an open problem for the community. The examples described herein tackle the problem of design and compression improvement of neural architectures.

Described herein is a content partitioning approach and tree representation for implicit neural representations and a parameter tree for such neural representations. The possible information to be carried for reconstruction and possible configurations are discussed. Further, a framework for INVR is provided.

The video coding in conventional video codecs exploits tree structures to improve the efficiency. Described herein is a similar approach for implicit neural representations. The herein described tree structure references the multimedia data such as visual data like a video frame. The examples described herein include a spatial and a spatio-temporal tree structure. The latter establishes a relation between a group of frames than a single frame.

Our video coding framework consists of two tree structures, the first handles partitioning the multimedia data and the second handles the reference to neural implicit representations. We, here, elaborate the data structures required and information that needs to be carried out.

### Multimedia Data Partitioning Aspect

### Spatial Partitioning Embodiment:

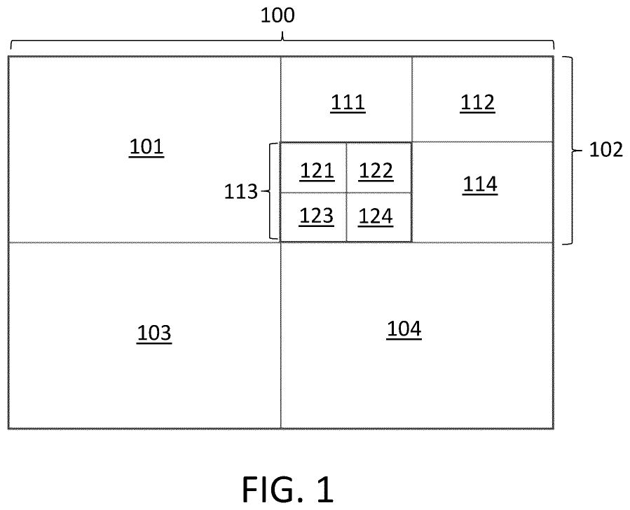

Given a stationary multimedia data, e.g., a single frame of a video or an image, the encoder determines splitting the data frame into spatial bins, the splitting could follow a quadtree or octree structure, where the point of splits is determined based on a metric distance between regions, e.g., a similarity metric between pre-determined grid cells fused into a region. For a 2D signal frame, here as an example, a video frame, at least 4 regions could be considered akin to FIG. 1.

FIG. 1 shows an example of partitioning of an input frame. In FIG. 1, the bins are even, in that bin 101, bin 102, bin 103, and bin 104 have the same size, bin 111, bin 112, bin 113, and bin 114 have the same size, and bin 121, bin 122, bin 123, and bin 124 have the same size. As shown in FIG. 1, the frame 100 is split into 4 even partitions that include bin 101, bin 102, bin 103, and bin 104. The bin 102 is partitioned into bin 111, bin 112, bin 113, and bin 114, and bin 113 is partitioned into bin 121, bin 122, bin 123, and bin 124.

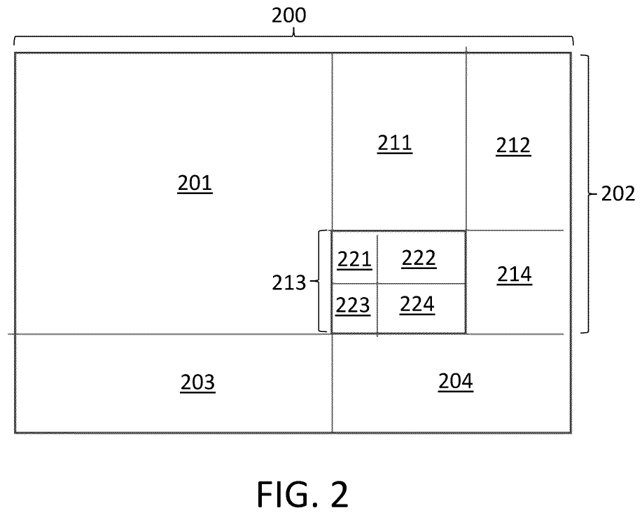

Instead of a pre-determined bin, the splitting principle may be applied, i.e., frame split into a known number of regions, e.g., 4 as in FIG. 1, but with uneven bins, where the size of each partition is determined by the content of the region. That allows the algorithm to employ intelligent AI-based partitioning using content analysis to determine at least a rectangular region that is suitable to partition. The same principle could be employed inside each partition. FIG. 2 shows the example of uneven frame split, or uneven partition.

In FIG. 2, the bins are uneven and determined based on the content of the region associated with the bin, and therefore may have different sizes (when the bins are determined based on the content of the region, the bins may have approximately the same size or the same size similar to FIG. 1).

As shown in FIG. 2, bin 201, bin 202, bin 203, and bin 204 have different sizes, bin 211, bin 212, bin 213, and bin 214 have different sizes, and bin 221, bin 222, bin 223, and bin 224 have different sizes. AI-based partitioning using content analysis may be used to determine the size and shape of the bins shown in FIG. 2.

As shown in FIG. 2, the frame 200 is split into 4 uneven partitions that include bin 201, bin 202, bin 203, and bin 204, where the size and shape of bin 201 is determined based on the content of the region associated with the bin 201, the size and shape of bin 202 is determined based on the content of the region associated with bin 202, the size and shape of bin 203 is determined based on the content associated with bin 203, and the size and shape of bin 204 is determined based on the content of the region associated with bin 204.

The bin 202 is partitioned into bin 211, bin 212, bin 213, and bin 214, where the size and shape of bin 211 is determined based on the content of the region associated with the bin 211, the size and shape of bin 212 is determined based on the content of the region associated with bin 212, the size and shape of bin 213 is determined based on the content associated with bin 213, and the size and shape of bin 214 is determined based on the content of the region associated with bin 214.

The bin 213 is partitioned into bin 221, bin 222, bin 223, and bin 224, where the size and shape of bin 221 is determined based on the content of the region associated with the bin 221, the size and shape of bin 222 is determined based on the content of the region associated with bin 222, the size and shape of bin 223 is determined based on the content associated with bin 223, and the size and shape of bin 224 is determined based on the content of the region associated with bin 224.

### Spatio-Temporal Partitioning Embodiment

In case of temporally changing data, e.g., video, the partitioning could be spatio-temporal, that is for a volume of data consisting of for example, m>1 frames, the volume is split into a voxel following same principles as even or uneven partitioning, akin to spatial partitioning explained above.

Learning the Data in Each Partition For INVR, a neural network architecture will learn the data represented in each partition. That is some areas of the data may be represented with multiple neural networks as part of a bigger and smaller sub-region. Each neural network will learn to produce the content of interest based on the one of the following types of information: the partition index, may be defined in terms of a x, y, z or x, y, t, referring to the location of the partition or simply a numerical index that follows a specific predetermined scanning approach that is determined by a scanning identifier. The neural network may receive some encoded vectorial or tensor information provided as input.

In specific an inner partition, a partition inside a partition, may depend on the tensorial information provided by a neural network that encodes the outer partition.

### Tree-Based Representation of the Partitioning in INVR

A tree-based representation is suggested for storing the information with respect to each partition. Each node of the tree will contain an identifier to determine the location of the multimedia content which they map to. This information includes the information such as x, y, z, t to allow localization of the output of a neural network in the multimedia content space for example an identifier to indicate the partition or voxel. The node of the tree may contain the information about the parent and siblings to identify them. The node of the tree may contain information about the identifier of a neural network that could produce the multimedia content, corresponding to the voxel or partition that the node represents. The node may contain information to identify if the neural network depends on an explicit encoding from the parent.

### Neural Network Parameter Tree

The provided identifier of the neural networks could be used to find them in a neural network parameter tree. The nodes of the parameter tree contain the following information, the weights of the neural network, information about the expected input, for example, the synthesized image or frame from the parent, the patch index information and a like. The information about the dimensions of the input image and the expected output size, e.g., width and height for the video frame. The parameter tree node will contain identifiers for determining the parent and children. It may also hold information about the order or relation with respect to the siblings. Each node of the tree may contain information about the compression that is applied on the weights of the neural network. Each node may contain information about whether the weights are updates or residuals with respect to another neural network weights that should be taken into account, such information may be provided in a one-time global fashion or with respect to each node of the tree, i.e., neural network.

Alternative to parameter tree, a hash-table approach could be used where alternatively could be used to look-up the relevant information from a hash-table and generate the content. Execution from hash table, may require extra information, e.g., input dependency for hierarchical calculation, e.g., pointer or hash key for the at least one previous dependent model if the calculations depend on the output of a previous model and if the weights are residual with respect to a model.

### Bitstream

The bitstream may follow a NAL unit structure, where for example one layer may consist of the information related to one node of a tree. It may include an identifier describing the location of the node of the tree, the parent or child relation, the URI to the neural network weights, an indicator if the NN weights are compressed or uncompressed, what compression is applied or alternatively a layer may contain the information. The information that are relevant and carried out inside each node of the tree may be included within the bitstream.

A NAL unit may be defined to carry the information about the multimedia content partition and the tree that describes the content partitioning. Such a unit may be communicated multiple times if the partitioning is time-varying. It may only contain an identifier indicating what is the pattern of the partition. If the partition is varying and partitions are even, the unit contains at least the information about each partition including not limited to location of the partition in multimedia content and the information related to the node of the tree, parent identifier and maybe information related to the siblings. Each node may include a URI to the location where the related neural network representation could be obtained.

Alternative to the direct URI for neural network representation for content partition tree, another unit may be defined to carry the information of the neural networks or the parameter tree. The parameter tree unit may contain information about the bit width of the neural networks. The parameter tree unit may contain the information to identify the neural architecture that defines the parameters of the neural network. It may carry a signature identifier or a URI to a location for fetching the neural network configuration information. The parameter tree may identify if the neural network weights are of residual nature or independent.

### Decoding and Execution

After the bitstream is parsed and the information related to the tree structure is shaped. Obtaining the node id information, if there is no tree structure previously built, a proper memory allocation for formation of a tree is allocated, and the fetched node information is inserted into the proper location in the tree structure.

The formation and execution of the nodes for reconstruction could happen together, that is once the partition information is fetched, the URI to NN allows obtaining the neural network for synthesizing or generating the information of interest, that is, the multimedia partition content is generated.

Building the content partition tree first and the parameter tree allows parallel execution of sibling neural networks for reconstruction of the content.

### Embodiment on Frame-Interpolation

The herein described INR may be used as a frame-interpolation technique in conjunction with conventional or end-to-end video compression methods.

### Embodiment on Skip Encoding and Tree Representation

In one embodiment, the tree structure may only have data for some of the multimedia content description. That is for some content partitions there will be no existing neural network representation and the representation obtained for a higher partition will suffice to reconstruct that partition. Nevertheless, a sibling partition of such a partition may still rely on at least one new representation.

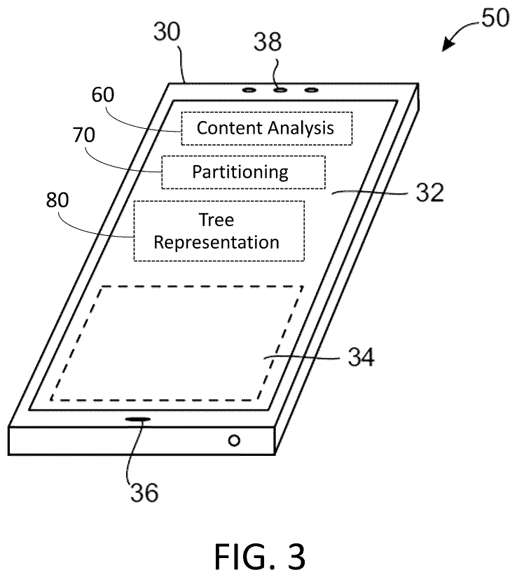

FIG. 3 shows a layout of an apparatus 50 according to an example embodiment. The electronic device 50 may for example be a mobile terminal or user equipment of a wireless communication system, a sensor device, a tag, or other lower power device. However, the embodiments of the examples described herein may be implemented within any electronic device or apparatus which may encode or decode multimedia content.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection. As shown in FIG. 3, apparatus 50 may include circuitry configured to perform content analysis 60, partitioning 70 based on the content analysis 60, and a tree-based representation 80 of the partitioning.

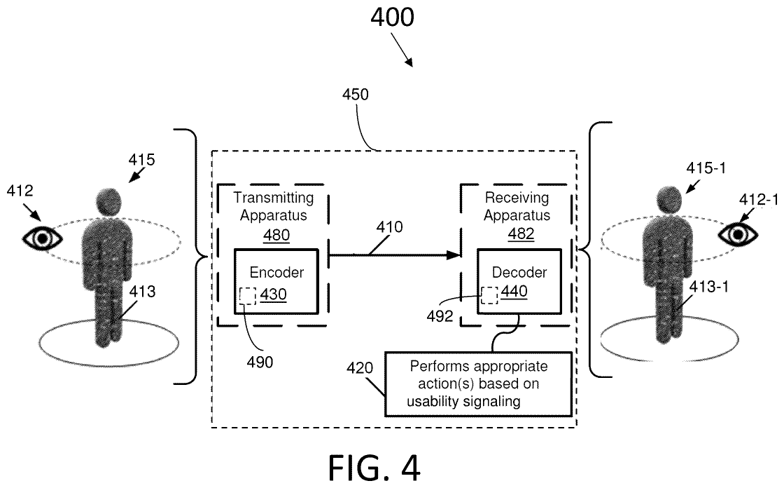

FIG. 4 is a block diagram illustrating a system 400 in accordance with several examples. In an example, the encoder 430 is used to encode an image or video from the scene 415, and the encoder 430 is implemented in a transmitting apparatus 480. The encoder 430 produces a bitstream 410 comprising signaling that is received by the receiving apparatus 482, which implements a decoder 440. The encoder 430 sends the bitstream 410 that comprises the herein described signaling. The decoder 440 forms the image or video for the scene 415-1, and the receiving apparatus 482 would present this to the user, e.g., via a smartphone, television, or projector among many other options.

In some examples, the transmitting apparatus 480 and the receiving apparatus 482 are at least partially within a common apparatus, and for example are located within a common housing 450. In other examples the transmitting apparatus 480 and the receiving apparatus 482 are at least partially not within a common apparatus and have at least partially different housings. Therefore in some examples, the encoder 430 and the decoder 440 are at least partially within a common apparatus, and for example are located within a common housing 450. For example the common apparatus comprising the encoder 430 and decoder 440 implements a codec. In other examples the encoder 430 and the decoder 440 are at least partially not within a common apparatus and have at least partially different housings, but when together still implement a codec.

In some examples, 3D media from the capture (e.g., volumetric capture) at a viewpoint 412 of the scene 415, which includes a person 413) is converted via projection to a series of 2D representations with occupancy, geometry, attributes and/or displacements. Additional atlas information is also included in the bitstream to enable inverse reconstruction. For decoding, the received bitstream 410 is separated into its components with atlas information; occupancy, geometry, displacement, and attribute 2D representations. A 3D reconstruction is performed to reconstruct the scene 415-1 created looking at the viewpoint 412-1 with a “reconstructed” person 413-1. The “-1” are used to indicate that these are reconstructions of the original. As indicated at 420, the decoder 440 performs an action or actions based on the received signaling.

Encoding 490 performs encoding of multimedia content based on the examples described herein, including partitioning based on AI content analysis and tree-based representation of partitioning. Decoding 492 performs decoding of the multimedia content, based on the examples described herein, including decoding of the partitioning based on AI content analysis and decoding of tree-based representation of partitioning.

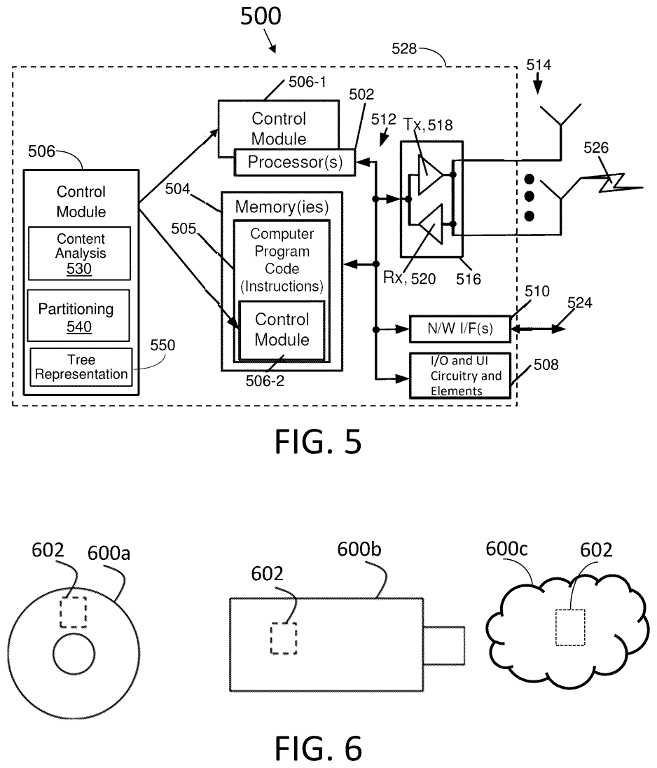

FIG. 5 is an example apparatus 500, which may be implemented in hardware, configured to implement the examples described herein. The apparatus 500 comprises at least one processor 502 (e.g., an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein.

Apparatus 500 may be a smartphone, personal digital device or assistant, smart television, laptop, tablet, head-mounted display (HMD) or other user device or terminal device. The memory 504 may be a non-transitory memory, a transitory memory, a volatile memory (e.g. RAM), or a non-volatile memory (e.g., ROM).

Content analysis 530 of the control module 506 implements the embodiments described herein related to AI based content analysis for partitioning 540. Tree representation 550 implements the embodiments described herein related to representing the partitioning 540 using a tree-based structure.

The apparatus 500 includes a display and/or I/O interface 508, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de)modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, one or more memories 504, and example algorithms (e.g., as flowcharts and/or signaling diagrams), encoded as instructions, programs, or code, are means for causing performance of the operations described herein.

The apparatus 500 to implement the functionality of control 506 may correspond to any of the apparatuses depicted herein. Alternatively, apparatus 500 and its elements may not correspond to any of the other apparatuses depicted herein, as apparatus 500 may be part of a self-organizing/optimizing network (SON) node or other node, such as a node in a cloud.

The apparatus 500 may also be distributed throughout the network including within and between apparatus 500 and any network element (such as a base station and/or terminal device and/or user equipment).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505. Computer program code (e.g. instructions) 505, including control 506 may comprise procedural, functional, or scripting code. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the operations of the methods described herein. Instructions and/or parameters 602 may represent or correspond to a non-transitory computer readable medium.

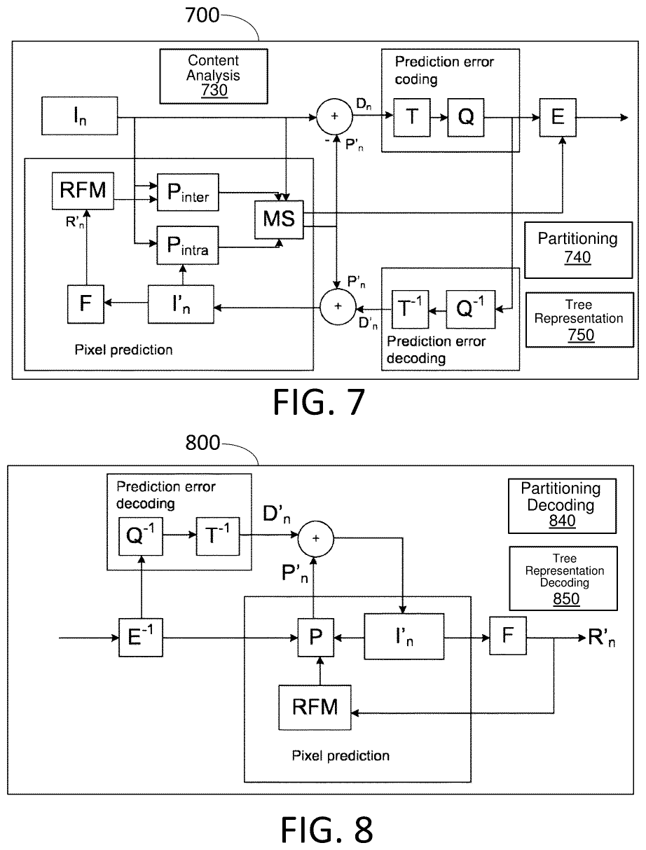

FIG. 7 shows an encoder 700 according to an embodiment. FIG. 7 illustrates an image to be encoded (Iⁿ), a predicted representation of an image block (Pⁿ), a prediction error signal (Dⁿ), a reconstructed prediction error signal (D′ⁿ), a preliminary reconstructed image (I′ⁿ), a final reconstructed image (Rⁿ), a transform (T) and inverse transform (T⁻¹), a quantization (Q) and inverse quantization (Q⁻¹), entropy encoding (E), a reference frame memory (RFM), inter prediction (P^{inter}), intra prediction (P^{intra}), mode selection (MS) and filtering (F). Content analysis 730 implements the embodiments described herein related to AI based content analysis for partitioning 740. Tree representation 750 implements the embodiments described herein related to representing the partitioning 740 using a tree-based structure.

FIG. 8 shows a decoder 800 according to an embodiment. FIG. 8 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Partitioning decoding 840 implements the embodiments described herein related to decoding of partitioning of content, where the partitioning is based on AI content analysis. Tree representation decoding 850 implements the embodiments described herein related to decoding the partitioning of the content from a tree-based structure.

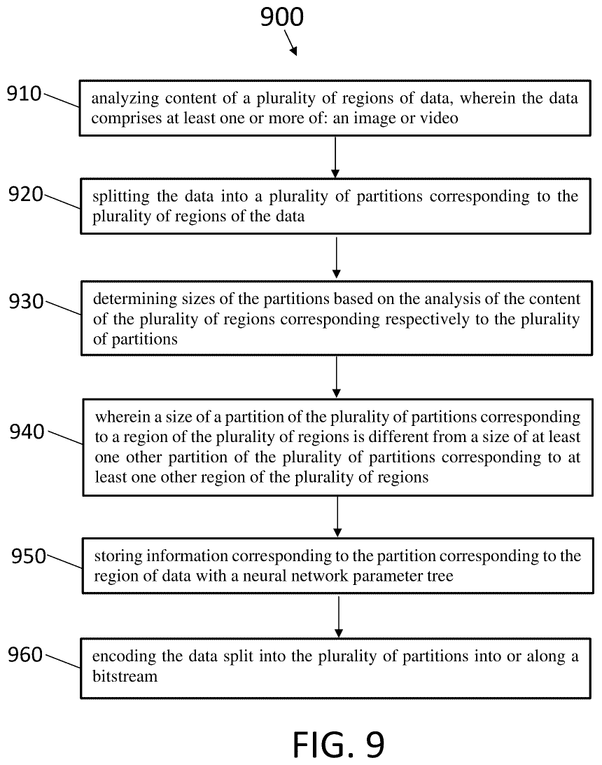

FIG. 9 is an example method 900, based on the examples described herein. At 910, the method includes analyzing content of a plurality of regions of data, wherein the data comprises at least one or more of: an image or video. At 920, the method includes splitting the data into a plurality of partitions corresponding to the plurality of regions of the data. At 930, the method includes determining sizes of the partitions based on the analysis of the content of the plurality of regions corresponding respectively to the plurality of partitions. At 940, the method includes wherein a size of a partition of the plurality of partitions corresponding to a region of the plurality of regions is different from a size of at least one other partition of the plurality of partitions corresponding to at least one other region of the plurality of regions. At 950, the method includes storing information corresponding to the partition corresponding to the region of data with a neural network parameter tree. At 960, the method includes encoding the data split into the plurality of partitions into or along a bitstream. Method 900 may be performed with apparatus 50, transmitting apparatus with encoder 430, apparatus 500, or encoder 700.

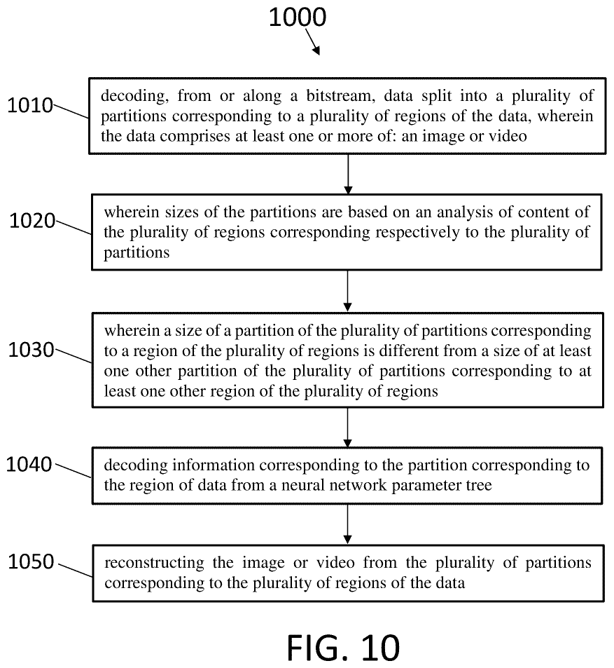

FIG. 10 is an example method 1000, based on the examples described herein. At 1010, the method includes decoding, from or along a bitstream, data split into a plurality of partitions corresponding to a plurality of regions of the data, wherein the data comprises at least one or more of: an image or video. At 1020, the method includes wherein sizes of the partitions are based on an analysis of content of the plurality of regions corresponding respectively to the plurality of partitions. At 1030, the method includes wherein a size of a partition of the plurality of partitions corresponding to a region of the plurality of regions is different from a size of at least one other partition of the plurality of partitions corresponding to at least one other region of the plurality of regions. At 1040, the method includes decoding information corresponding to the partition corresponding to the region of data from a neural network parameter tree. At 1050, the method includes reconstructing the image or video from the plurality of partitions corresponding to the plurality of regions of the data. Method 1000 may be performed with apparatus 50, receiving apparatus with decoder 440, apparatus 500, or decoder 800.

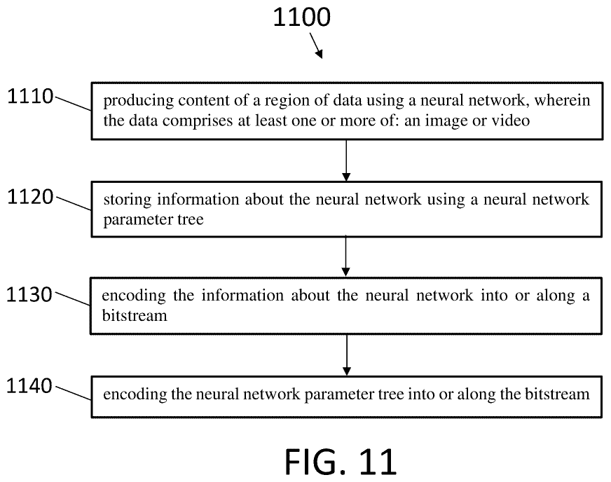

FIG. 11 is an example method 1100, based on the examples described herein. At 1110, the method includes producing content of a region of data using a neural network, wherein the data comprises at least one or more of: an image or video. At 1120, the method includes storing information about the neural network using a neural network parameter tree. At 1130, the method includes encoding the information about the neural network into or along a bitstream. At 1140, the method includes encoding the neural network parameter tree into or along the bitstream. Method 1100 may be performed with apparatus 50, transmitting apparatus with encoder 430, apparatus 500, or encoder 700.

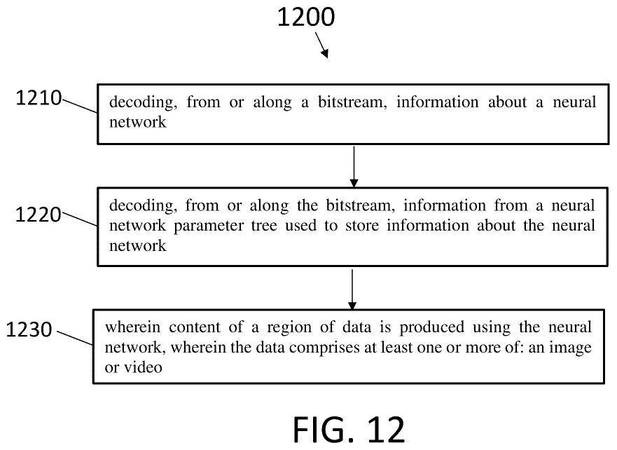

FIG. 12 is an example method 1200, based on the examples described herein. At 1210, the method includes decoding, from or along a bitstream, information about a neural network. At 1220, the method includes decoding, from or along the bitstream, information from a neural network parameter tree used to store information about the neural network. At 1230, the method includes wherein content of a region of data is produced using the neural network, wherein the data comprises at least one or more of: an image or video. Method 1200 may be performed with apparatus 50, receiving apparatus with decoder 440, apparatus 500, or decoder 800.

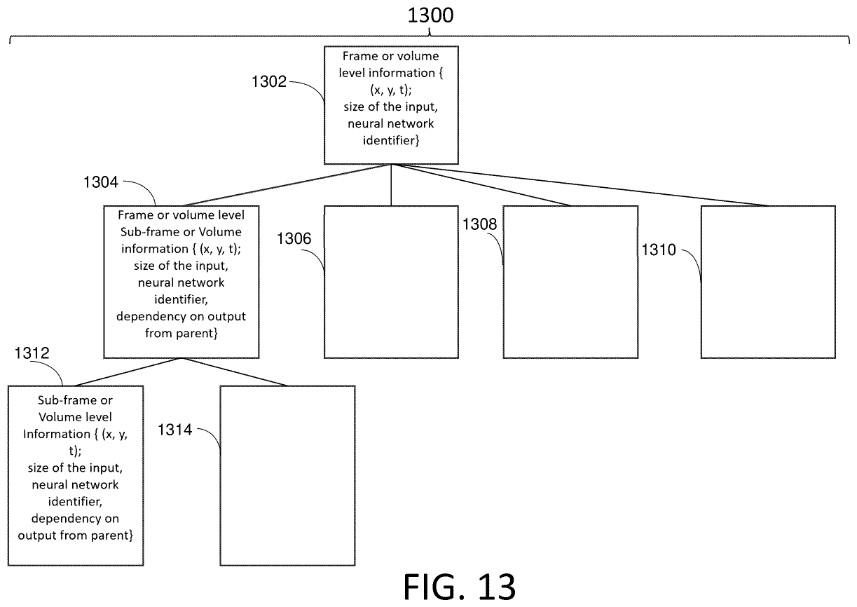

FIG. 13 demonstrates an example INR tree 1300 and some of the information the INR tree 130 incorporates about each content partition with respect to a frame or volume as the input. For example, the root 1302 is the highest volume or frame and the second-level children (node 1304, node 1306, node 1308, node 1310) represent the sub-frames or sub-volumes to be processed. In the third level (node 1312, node 1314), the nodes have or store the sub-sub volumes and so on. This information is used to allow for example, higher-quality content generation or progressive content generation if necessary. The neural network identifier could be used to fetch the relevant neural network from a parameter update tree or a hash table. As shown in FIG. 13, root 1302 includes Frame or volume level information {(x, y, t); size of the input, neural network identifier}, node 1304 includes Frame or volume level Sub-frame or Volume information {(x, y, t); size of the input, neural network identifier, dependency on output from parent}, and node 1312 includes Sub-frame or Volume level Information {(x, y, t); size of the input, neural network identifier, dependency on output from parent}.

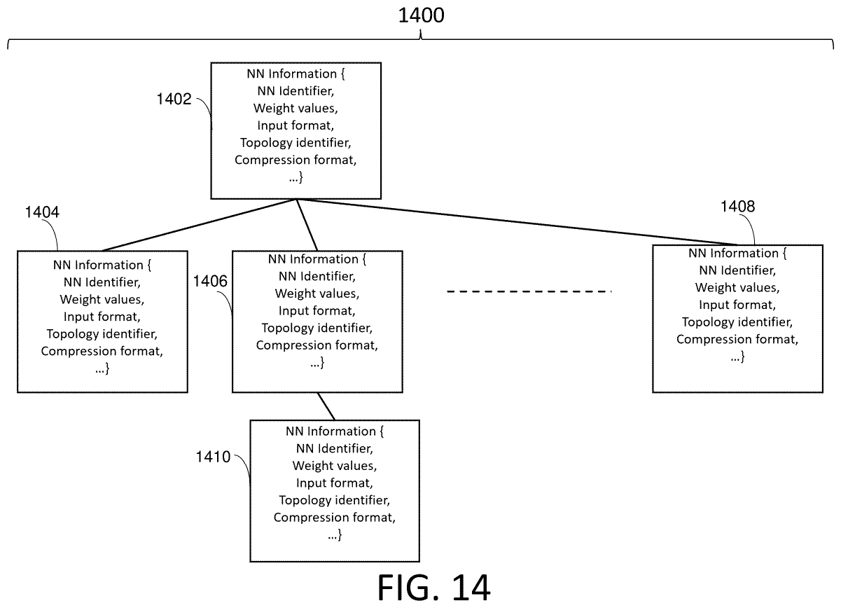

FIG. 14 shows an example neural network tree 1400. Neural network tree 1400 includes information about the neural networks that produce the content within the INR decoding process. A node could have as many as possible children. Each child indicates that it represents an update with respect to the parent. For example, child node 1410 indicates that child node 1410 represents an update with respect to its parent node 1406. Thus, a weight update to the parent could apply to derive a child true value. Example information could include weights and values, compression method on top of the weights, the input format and alike. As shown in FIG. 14, root 1402, node 1404, node 1406, node 1408, and node 1410 include NN Information {NN Identifier, Weight values, Input format, Topology identifier, Compression format, . . . }.

The following examples are provided and described herein.
Example 1. An apparatus including: at least one processor; and at least one memory storing instructions that, when executed by the at least one processor, cause the apparatus at least to: analyze content of a plurality of regions of data, wherein the data comprises at least one or more of: an image or video; split the data into a plurality of partitions corresponding to the plurality of regions of the data; determine sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; store information corresponding to the partition corresponding to the region of data with a neural network parameter tree; and encode the data split into the plurality of partitions into or along a bitstream.
Example 2. The apparatus of example 1, wherein the instructions, when executed by the at least one processor, cause the apparatus at least to: determine a point where the partition is split between another partition of the plurality of partitions, based on a metric distance between the region corresponding to the partition and another region corresponding to the another partition.
Example 3. The apparatus of any of examples 1 to 2, wherein the content of the plurality of regions of the data is analyzed using an artificial intelligence method.
Example 4. The apparatus of any of examples 1 to 3, wherein the data comprises an image, and the data is split into the plurality of partitions spatially.
Example 5. The apparatus of any of examples 1 to 4, wherein the data comprises a volume of the video, and the volume is split spatio-temporally into a voxel as the partition.
Example 6. The apparatus of any of examples 1 to 5, wherein the instructions, when executed by the at least one processor, cause the apparatus at least to: produce the content of the region of data using a neural network based on at least one of: a partition index that refers to a location of the partition, or a numerical index that follows a scanning approach determined with a scanning identifier.
Example 7. The apparatus of any of examples 1 to 6, wherein a node of the neural network parameter tree comprises at least one of: an identifier of a location of the content of the region corresponding to the partition, or an identifier of a neural network used to produce the content of the region corresponding to the partition, or information to determine whether a neural network used to produce the content of the region corresponding to the partition depends on an encoding of a parent node of the node of the neural network parameter tree.
Example 8. The apparatus of any of examples 1 to 7, wherein the instructions, when executed by the at least one processor, cause the apparatus at least to: produce the content of the region of data using a neural network; and store information about the neural network using the neural network parameter tree.
Example 9. The apparatus of example 8, wherein a node of the neural network parameter tree comprises at least one of: weights of the neural network, or information about an expected input, wherein the expected input comprises: a synthesized image, a frame from a parent node of the node of the neural network parameter tree, or patch index information, or information about dimensions of an input image and an expected output size related to a width and height for a video frame, or identifiers for determining parent nodes of the node of the neural network parameter tree and child nodes of the node of the neural network parameter tree, or information about an order or relation with respect to sibling nodes of the node of the neural network parameter tree, or information about compression that is applied on weights of the neural network, or information about whether weights of the neural network are updates or residuals.
Example 10. The apparatus of any of examples 1 to 9, wherein the instructions, when executed by the at least one processor, cause the apparatus at least to: produce the content of the region of data using a hash table; wherein a pointer or hash key of the hash table is used to determine calculations from a previous model or residual weights with respect to a model.
Example 11. The apparatus of any of examples 1 to 10, wherein encoding the data split into the plurality of partitions into or along the bitstream is performed with a network abstraction layer unit structure, wherein a layer of the network abstraction layer unit structure comprises information related to a node of the neural network parameter tree used to store information for a neural network used to produce the content of the region of data.
Example 12. The apparatus of any of examples 1 to 11, wherein the instructions, when executed by the at least one processor, cause the apparatus at least to: encode information about the partition corresponding to the region of the data into a network abstraction layer unit; and encode information about the neural network parameter tree describing the plurality of partitions into the network abstraction layer unit.
Example 13. The apparatus of any of examples 1 to 12, wherein the instructions, when executed by the at least one processor, cause the apparatus at least to: produce the content of the region of data corresponding to the partition using a neural network; and produce content of another region of data corresponding to another partition using the neural network, when content of the another region of data corresponding to the another partition is not represented with another neural network.
Example 14. An apparatus including: at least one processor; and at least one memory storing instructions that, when executed by the at least one processor, cause the apparatus at least to: decode, from or along a bitstream, data split into a plurality of partitions corresponding to a plurality of regions of the data, wherein the data comprises at least one or more of: an image or video; wherein sizes of the partitions are based on an analysis of content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; decode information corresponding to the partition corresponding to the region of data from a neural network parameter tree; and reconstruct the image or video from the plurality of partitions corresponding to the plurality of regions of the data.
Example 15. The apparatus of example 14, wherein a point where the partition is split between another partition of the plurality of partitions is based on a metric distance between the region corresponding to the partition and another region corresponding to the another partition.
Example 16. The apparatus of any of examples 14 to 15, wherein the analysis of the content of the plurality of regions is performed with an artificial intelligence method.
Example 17. The apparatus of any of examples 14 to 16, wherein the data comprises an image, and the data is split into the plurality of partitions spatially.
Example 18. The apparatus of any of examples 14 to 17, wherein the data comprises a volume of the video, and the volume is split spatio-temporally into a voxel as the partition.
Example 19. The apparatus of any of examples 14 to 18, wherein the content of the region of data is produced using a neural network based on at least one of: a partition index that refers to a location of the partition, or a numerical index that follows a scanning approach determined with a scanning identifier.
Example 20. The apparatus of any of examples 14 to 19, wherein a node of the neural network parameter tree comprises at least one of: an identifier of a location of the content of the region corresponding to the partition, or an identifier of a neural network used to produce the content of the region corresponding to the partition, or information to determine whether a neural network used to produce the content of the region corresponding to the partition depends on an encoding of a parent node of the node of the neural network parameter tree.
Example 21. The apparatus of any of examples 14 to 20, wherein the instructions, when executed by the at least one processor, cause the apparatus at least to: decode information about a neural network used to produce content of the region of the data from the neural network parameter tree.
Example 22. The apparatus of example 21, wherein the instructions, when executed by the at least one processor, cause the apparatus at least to decode from a node of the neural network parameter tree at least one of: weights of the neural network, or information about an expected input, wherein the expected input comprises: a synthesized image, a frame from a parent node of the node of the neural network parameter tree, or patch index information, or information about dimensions of an input image and an expected output size related to a width and height for a video frame, or identifiers for determining parent nodes of the node and child nodes of the node, or information about an order or relation with respect to sibling nodes of the node of the neural network parameter tree, or information about compression that is applied on weights of the neural network, or information about whether weights of the neural network are updates or residuals.
Example 23. The apparatus of any of examples 14 to 22, wherein: content of the region of data is produced using a hash table; and a pointer or hash key of the hash table is used to determine calculations from a previous model or residual weights with respect to a model.
Example 24. The apparatus of any of examples 14 to 23, wherein the data split into the plurality of partitions is decoded from or along the bitstream from a network abstraction layer unit structure, wherein a layer of the network abstraction layer unit structure comprises information related to a node of the neural network parameter tree used to store information for a neural network used to produce the content of the region of data.
Example 25. The apparatus of any of examples 14 to 24, wherein the instructions, when executed by the at least one processor, cause the apparatus at least to: decode information about the partition corresponding to the region of the data from a network abstraction layer unit; and decode information about a tree describing the plurality of partitions from the network abstraction layer unit.
Example 26. The apparatus of any of examples 14 to 25, wherein the instructions, when executed by the at least one processor, cause the apparatus at least to: decode information about the partition corresponding to the region of the data from a tree; wherein the content of the region of data corresponding to the partition is produced using a neural network; wherein content of another region of data corresponding to another partition is produced using the neural network, when content of the another region of data corresponding to the another partition is not represented with another neural network.
Example 27. An apparatus including: at least one processor; and at least one memory storing instructions that, when executed by the at least one processor, cause the apparatus at least to: produce content of a region of data using a neural network, wherein the data comprises at least one or more of: an image or video; store information about the neural network using a neural network parameter tree; encode the information about the neural network into or along a bitstream; and encode the neural network parameter tree into or along the bitstream.
Example 28. The apparatus of example 27, wherein a node of the parameter tree comprises at least one of: weights of the neural network, information about an expected input, wherein the expected input comprises: a synthesized image, a frame from a parent node of the node of the parameter tree, or a patch index information, or information about dimensions of an input image and an expected output size related to a width and height for a video frame, or identifiers for determining parent nodes of the node of the parameter tree and child nodes of the node of the parameter tree, or information about an order or relation with respect to sibling nodes of the node of the parameter tree, or information about compression that is applied on weights of the neural network, or information about whether weights of the neural network are updates or residuals.
Example 29. The apparatus of any of examples 27 to 28, wherein the instructions, when executed by the at least one processor, cause the apparatus at least to: encode information about the neural network parameter tree into a network abstraction layer unit.
Example 30. An apparatus including: at least one processor; and at least one memory storing instructions that, when executed by the at least one processor, cause the apparatus at least to: decode, from or along a bitstream, information about a neural network; and decode, from or along the bitstream, information from a neural network parameter tree used to store information about the neural network; wherein content of a region of data is produced using the neural network, wherein the data comprises at least one or more of: an image or video.
Example 31. The apparatus of example 30, wherein a node of the parameter tree comprises at least one of: weights of the neural network, information about an expected input, wherein the expected input comprises: a synthesized image, a frame from a parent node of the node of the parameter tree, or a patch index information, or information about dimensions of an input image and an expected output size related to a width and height for a video frame, or identifiers for determining parent nodes of the node of the parameter tree and child nodes of the node of the parameter tree, or information about an order or relation with respect to sibling nodes of the node of the parameter tree, or information about compression that is applied on weights of the neural network, or information about whether weights of the neural network are updates or residuals.
Example 32. The apparatus of any of examples 30 to 31, wherein the instructions, when executed by the at least one processor, cause the apparatus at least to: decode information about the neural network parameter tree from a network abstraction layer unit.
Example 33. A method including: analyzing content of a plurality of regions of data, wherein the data comprises at least one or more of: an image or video; splitting the data into a plurality of partitions corresponding to the plurality of regions of the data; determining sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; storing information corresponding to the partition corresponding to the region of data with a neural network parameter tree; and encoding the data split into the plurality of partitions into or along a bitstream.
Example 34. A method including: decoding, from or along a bitstream, data split into a plurality of partitions corresponding to a plurality of regions of the data, wherein the data comprises at least one or more of: an image or video; wherein sizes of the partitions are based on an analysis of content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; decoding information corresponding to the partition corresponding to the region of data from a neural network parameter tree; and reconstructing the image or video from the plurality of partitions corresponding to the plurality of regions of the data.
Example 35. A method including: producing content of a region of data using a neural network, wherein the data comprises at least one or more of: an image or video; storing information about the neural network using a neural network parameter tree; encoding the information about the neural network into or along a bitstream; and encoding the neural network parameter tree into or along the bitstream.
Example 36. A method including: decoding, from or along a bitstream, information about a neural network; and decoding, from or along the bitstream, information from a neural network parameter tree used to store information about the neural network; wherein content of a region of data is produced using the neural network, wherein the data comprises at least one or more of: an image or video.
Example 37. An apparatus including: means for analyzing content of a plurality of regions of data, wherein the data comprises at least one or more of: an image or video; means for splitting the data into a plurality of partitions corresponding to the plurality of regions of the data; means for determining sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; means for storing information corresponding to the partition corresponding to the region of data with a neural network parameter tree; and means for encoding the data split into the plurality of partitions into or along a bitstream.
Example 38. An apparatus including: means for decoding, from or along a bitstream, data split into a plurality of partitions corresponding to a plurality of regions of the data, wherein the data comprises at least one or more of: an image or video; wherein sizes of the partitions are based on an analysis of content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; means for decoding information corresponding to the partition corresponding to the region of data from a neural network parameter tree; and means for reconstructing the image or video from the plurality of partitions corresponding to the plurality of regions of the data.
Example 39. An apparatus including: means for producing content of a region of data using a neural network, wherein the data comprises at least one or more of: an image or video; means for storing information about the neural network using a neural network parameter tree; means for encoding the information about the neural network into or along a bitstream; and means for encoding the neural network parameter tree into or along the bitstream.
Example 40. An apparatus including: means for decoding, from or along a bitstream, information about a neural network; and means for decoding, from or along the bitstream, information from a neural network parameter tree used to store information about the neural network; wherein content of a region of data is produced using the neural network, wherein the data comprises at least one or more of: an image or video.
Example 41. A computer readable medium including instructions stored thereon for performing at least the following: analyzing content of a plurality of regions of data, wherein the data comprises at least one or more of: an image or video; splitting the data into a plurality of partitions corresponding to the plurality of regions of the data; determining sizes of the partitions based on the analysis of the content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; storing information corresponding to the partition corresponding to the region of data with a neural network parameter tree; and encoding the data split into the plurality of partitions into or along a bitstream.
Example 42. A computer readable medium including instructions stored thereon for performing at least the following: decoding, from or along a bitstream, data split into a plurality of partitions corresponding to a plurality of regions of the data, wherein the data comprises at least one or more of: an image or video; wherein sizes of the partitions are based on an analysis of content of the plurality of regions corresponding respectively to the plurality of partitions; wherein a size of a partition of the plurality of partitions corresponding to a region of the plurality of regions is different from a size of at least one other partition of the plurality of partitions corresponding to at least one other region of the plurality of regions; decoding information corresponding to the partition corresponding to the region of data from a neural network parameter tree; and reconstructing the image or video from the plurality of partitions corresponding to the plurality of regions of the data.
Example 43. A computer readable medium including instructions stored thereon for performing at least the following: producing content of a region of data using a neural network, wherein the data comprises at least one or more of: an image or video; storing information about the neural network using a neural network parameter tree; encoding the information about the neural network into or along a bitstream; and encoding the neural network parameter tree into or along the bitstream.
Example 44. A computer readable medium including instructions stored thereon for performing at least the following: decoding, from or along a bitstream, information about a neural network; and decoding, from or along the bitstream, information from a neural network parameter tree used to store information about the neural network; wherein content of a region of data is produced using the neural network, wherein the data comprises at least one or more of: an image or video.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
ASIC application specific integrated circuit
CPU central processing unit
FPGA field programmable gate array
HMD head mounted display
I/F interface
INR implicit neural representation
INVR implicit neural visual representations
I/O input/output
NAL network abstraction layer
NN neural network
N/W network
RAM random access memory
ROM read only memory
SON self-organizing/optimizing network
UI user interface
URI uniform resource identifier
USB universal serial bus

1. An apparatus comprising:
at least one processor; and
at least one memory storing instructions that, when executed by the at least one processor, cause the apparatus at least to:
analyze content of a plurality of regions of data, wherein the data comprises at least one or more of: an image or video;
split the data into a plurality of partitions corresponding to the plurality of regions of the data;
determine sizes of the partitions based on the analysis of the content of the plurality of regions corresponding respectively to the plurality of partitions;
wherein a size of a partition of the plurality of partitions corresponding to a region of the plurality of regions is different from a size of at least one other partition of the plurality of partitions corresponding to at least one other region of the plurality of regions;
store information corresponding to the partition corresponding to the region of data with a neural network parameter tree; and
encode the data split into the plurality of partitions into or along a bitstream.

2. The apparatus of claim 1, wherein the instructions, when executed by the at least one processor, cause the apparatus at least to:
determine a point where the partition is split between another partition of the plurality of partitions, based on a metric distance between the region corresponding to the partition and another region corresponding to the another partition.

3.-5. (canceled)

6. The apparatus of claim 1, wherein the instructions, when executed by the at least one processor, cause the apparatus at least to:
produce the content of the region of data using a neural network based on at least one of: a partition index that refers to a location of the partition, or a numerical index that follows a scanning approach determined with a scanning identifier.

7. The apparatus of claim 1, wherein a node of the neural network parameter tree comprises at least one of:
an identifier of a location of the content of the region corresponding to the partition, or
an identifier of a neural network used to produce the content of the region corresponding to the partition, or
information to determine whether a neural network used to produce the content of the region corresponding to the partition depends on an encoding of a parent node of the node of the neural network parameter tree.

8. The apparatus of claim 1, wherein the instructions, when executed by the at least one processor, cause the apparatus at least to:
produce the content of the region of data using a neural network; and
store information about the neural network using the neural network parameter tree.

9. The apparatus of claim 8, wherein a node of the neural network parameter tree comprises at least one of:
weights of the neural network, or
information about an expected input, wherein the expected input comprises: a synthesized image, a frame from a parent node of the node of the neural network parameter tree, or patch index information, or
information about dimensions of an input image and an expected output size related to a width and height for a video frame, or
identifiers for determining parent nodes of the node of the neural network parameter tree and child nodes of the node of the neural network parameter tree, or
information about an order or relation with respect to sibling nodes of the node of the neural network parameter tree, or
information about compression that is applied on weights of the neural network, or
information about whether weights of the neural network are updates or residuals.

10. The apparatus of claim 1, wherein the instructions, when executed by the at least one processor, cause the apparatus at least to:
produce the content of the region of data using a hash table;
wherein a pointer or hash key of the hash table is used to determine calculations from a previous model or residual weights with respect to a model.

11. The apparatus of claim 1, wherein encoding the data split into the plurality of partitions into or along the bitstream is performed with a network abstraction layer unit structure, wherein a layer of the network abstraction layer unit structure comprises information related to a node of the neural network parameter tree used to store information for a neural network used to produce the content of the region of data.

12.-13. (canceled)

14. An apparatus comprising:
at least one processor; and
at least one memory storing instructions that, when executed by the at least one processor, cause the apparatus at least to:
decode, from or along a bitstream, data split into a plurality of partitions corresponding to a plurality of regions of the data, wherein the data comprises at least one or more of: an image or video;
wherein sizes of the partitions are based on an analysis of content of the plurality of regions corresponding respectively to the plurality of partitions;
wherein a size of a partition of the plurality of partitions corresponding to a region of the plurality of regions is different from a size of at least one other partition of the plurality of partitions corresponding to at least one other region of the plurality of regions;
decode information corresponding to the partition corresponding to the region of data from a neural network parameter tree; and
reconstruct the image or video from the plurality of partitions corresponding to the plurality of regions of the data.

15. The apparatus of claim 14, wherein a point where the partition is split between another partition of the plurality of partitions is based on a metric distance between the region corresponding to the partition and another region corresponding to the another partition.

16.-18. (canceled)

19. The apparatus of claim 14, wherein the content of the region of data is produced using a neural network based on at least one of: a partition index that refers to a location of the partition, or a numerical index that follows a scanning approach determined with a scanning identifier.

20. The apparatus of claim 14, wherein a node of the neural network parameter tree comprises at least one of:
an identifier of a location of the content of the region corresponding to the partition, or
an identifier of a neural network used to produce the content of the region corresponding to the partition, or
information to determine whether a neural network used to produce the content of the region corresponding to the partition depends on an encoding of a parent node of the node of the neural network parameter tree.

21. The apparatus of claim 14, wherein the instructions, when executed by the at least one processor, cause the apparatus at least to:
decode information about a neural network used to produce content of the region of the data from the neural network parameter tree.

22. The apparatus of claim 21, wherein the instructions, when executed by the at least one processor, cause the apparatus at least to decode from a node of the neural network parameter tree at least one of:
weights of the neural network, or
information about an expected input, wherein the expected input comprises: a synthesized image, a frame from a parent node of the node of the neural network parameter tree, or patch index information, or
information about dimensions of an input image and an expected output size related to a width and height for a video frame, or
identifiers for determining parent nodes of the node and child nodes of the node, or
information about an order or relation with respect to sibling nodes of the node of the neural network parameter tree, or
information about compression that is applied on weights of the neural network, or
information about whether weights of the neural network are updates or residuals.

23. The apparatus of claim 14, wherein:
content of the region of data is produced using a hash table; and
a pointer or hash key of the hash table is used to determine calculations from a previous model or residual weights with respect to a model.

24. The apparatus of claim 14, wherein the data split into the plurality of partitions is decoded from or along the bitstream from a network abstraction layer unit structure, wherein a layer of the network abstraction layer unit structure comprises information related to a node of the neural network parameter tree used to store information for a neural network used to produce the content of the region of data.

25. The apparatus of claim 14, wherein the instructions, when executed by the at least one processor, cause the apparatus at least to:
decode information about the partition corresponding to the region of the data from a network abstraction layer unit; and
decode information about a tree describing the plurality of partitions from the network abstraction layer unit.

26. The apparatus of claim 14, wherein the instructions, when executed by the at least one processor, cause the apparatus at least to:
decode information about the partition corresponding to the region of the data from a tree;
wherein the content of the region of data corresponding to the partition is produced using a neural network;
wherein content of another region of data corresponding to another partition is produced using the neural network, when content of the another region of data corresponding to the another partition is not represented with another neural network.

27. An apparatus comprising:
at least one processor; and
at least one memory storing instructions that, when executed by the at least one processor, cause the apparatus at least to:
produce content of a region of data using a neural network, wherein the data comprises at least one or more of: an image or video;
store information about the neural network using a neural network parameter tree;
encode the information about the neural network into or along a bitstream; and
encode the neural network parameter tree into or along the bitstream.

28.-29. (canceled)

30. An apparatus comprising:
at least one processor; and
at least one memory storing instructions that, when executed by the at least one processor, cause the apparatus at least to:
decode, from or along a bitstream, information about a neural network; and
decode, from or along the bitstream, information from a neural network parameter tree used to store information about the neural network;
wherein content of a region of data is produced using the neural network, wherein the data comprises at least one or more of: an image or video.

31.-44. (canceled)
